(19) United States
(12) Patent Application Publication
(10) Pub. No.: US 2008/0159181 A1
(43) Pub. Date: Jul. 3, 2008

(54) CID-Based and Group-ID Oriented Call-Gating, Information Processing, Message Pre-Emption and Response-Multiplexing for SmartPhones, TADs and Networks

(76) Inventor: David Toms Anderson, Corvallis, OR (US)

Correspondence Address: DAVID TOMS ANDERSON, 220 SW AVERY AVE., CORVALLIS, OR, 97333-1141, US

(21) Appl. No.: 11/618,819

(22) Filed: Dec. 30, 2006

(51) Int. Cl. H04L 12/16

(52) U.S. Cl. 370/271

(57) ABSTRACT

A method of managing input/output/access options and caller greetings within a SmartPhone (or similar) environment. The method is based on grouping Caller IDs (CIDs) of like community, activity, achievement, interests or functionality. These groups are assigned a Group ID code (GID) conferring specific rights to callers through GID-profiles and menu and scripting options that are capable of drawing upon a prescribed suite of variables linked to files, resident applications and peripherals. Rights are further augmented if the CID is associated with multiple GIDs or conferred individual rights. Unlinked CIDs are further scanned for matching prefix-based (area code) GIDs, thus presenting the possibility of individual (rather than governmental) control of Do Not Call (DNC) functionality. This method links personal digital assistant (PDA) features and native software with mobile communication functions and provides a common gateway for Short Message Service, Multi-media Message Service, email and voice messaging—all leveraged through GID codes.

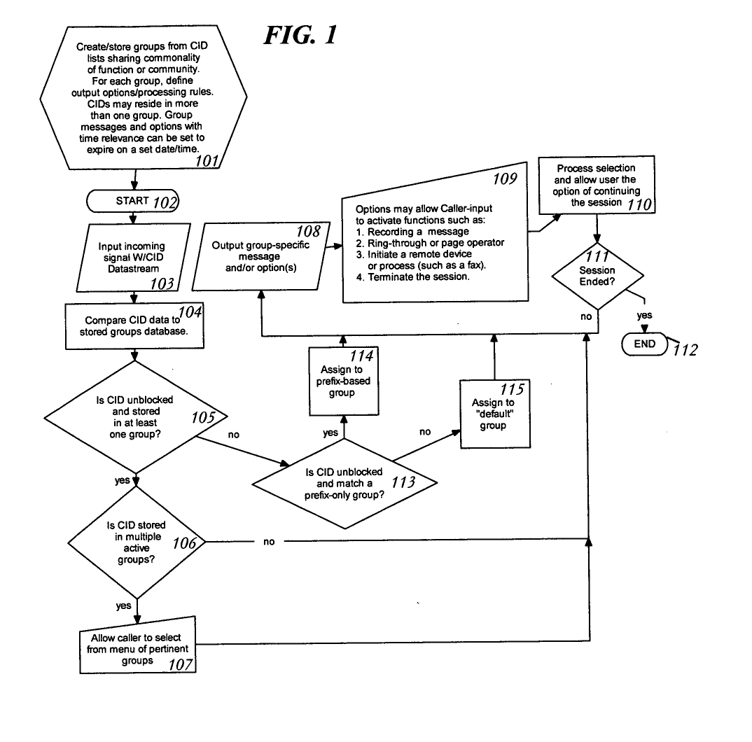

### FIELD OF THE INVENTION

The present invention (hereafter referred to as Grouper), relates generally to SmartPhones, mobile communications environments and Telephone Answering Devices (TADs) and, more particularly, to a method of managing input/output/access options and greeting selections based on group designations sensitive to community, activity, achievement, commonality of interests, commonality of function, communication equipment specifications or any combination thereof.

In a preferred embodiment of the system, Grouper resides on the called (owner's) SmartPhone (Sphone). It may also reside on a personal computer (PC) connected to a phone line via a TAPI-compliant or other appropriate device for enabling telephone functions. It may also reside (with diminished capability) on a TAD.

Grouper integrates the multiple features of a personal digital assistant (PDA) with mobile communication functions and leverages this synthesis through the Group Identification Code (GID) and menu and scripting options, thus conferring specific rights to callers through GID-profiles. The resulting novel Communications Management Software (CMS) addresses existing and anticipated problems while conveying capabilities far exceeding those found in prior art.

Grouper directs options to callers with an owner-determined degree of specificity ranging from broad-spectrum groups to specific callers in manner suggestive of a pharmaceutical designed to bind a receptor common to many or few organisms. Individuals placed under a common GID are conferred rights through its profile and endowed with a range of functionality contained within those rights. These rights can be further augmented if the caller ID (CID) is associated with multiple GIDs or is conferred individual rights. Rights are accessible through menu and scripting options that may draw upon Grouper's pre-ordained list of variables as well as owner-designed, scripted variables.

Grouper can be used to provide a common gateway and repository for Short Message Service (SMS), Multi-media Message Service (MMS), email and voice messaging, as well as formats not yet known. If a CID is not recognized in its entirety, Grouper can parse the CID and distinguish whether a match exists in a prefix-based group. Such prefix-based groups are a logical solution to eventual empowerment of individual (rather than governmental) control of Do Not Call (DNC) functionality.

### BACKGROUND AND SUMMARY OF THE INVENTION

Detailed descriptions of the preferred embodiment of Grouper are provided herein. It is to be understood that it may be embodied in other forms. Specific details disclosed herein are meant to clarify and not limit the embodiment and cover such alternatives, modifications and equivalents as may be included within the spirit and scope of the invention as defined by the claims.

SmartPhones (Sphones) integrate the functionality of a mobile phone and PDA. A noteworthy provision of an Sphone is that it runs a complete operating system and permits the installation of additional native applications.

A November 2006 survey by In-Stat (http://www.instat.com/) claims 75 percent of Sphone users also carry a PDA and only 43 percent anticipate higher productivity with Sphone usage. Such statistics clearly speak to the lack of integration within the powerful Sphone platform.

The many hats worn by individuals in today's society necessitate screening, messaging and advanced gateway management options that explicitly address the most important components of an individual's shared communication communities. An Sphone environment is well suited to this function. The Sphone platform's ever-increasing storage capacity, processor speed and mobile connectivity provide the potential for innovative time-saving opportunities. It is one of many anticipated development platforms well suited for Grouper.

After proper configuration, Grouper is ready to respond to an incoming call. It first determines whether the incoming CID (if any) is a subset of an owner-defined GID and, depending upon rights conferred by the owner (within the GID-profile and GID-specific menus and greetings), allows group members to interact with GID-gated sections of the owner's Sphone. The GID-profile defines, for each group, input/output/access options, processing options, viewing rights and expiration rules. For instance, callers may receive group-specific information from greetings that contain variables linked to contact databases, calendars, clocks, spreadsheets and other databases. Such greetings may be audio, SMS or MMS greetings. Furthermore, the caller may be presented with menus permitting the upload or download of files within the purview of the group. Or, the caller maybe granted the ability to view GID-Gated PowerPoint, DOC or PDF files, oOr the ability to update CID-gated contact information, or the ability to view GID-gated data from linked peripheral devices.

By allowing for the password protection of user gateways as well as verification of the machine identification code, Grouper protects Sphone data to the extent required by each function.

Another aspect of the present invention is the ability to preemptively deliver information to a caller, according to an owner-defined script, without owner intervention. In a very narrow example of this functionality, a caller identified within a particular group might, without input by the caller or owner, be conveyed with SMS, MMS or text-reader generated audio greeting that contains information about the next meeting (derived through a scripted retrieval of GID-tagged information from the owner's calendar).

Likewise, the caller might automatically be sent the latest draft of a research paper—arranged by comparing the “last call date/time” stored in the contact file, the file header date/time information and the clock/calendar information on the Sphone. If a paper has not been updated since last visit, the Sphone may auto-respond with an SMS message indicating such.

Clearly, the proliferation and sophistication of Sphones will rapidly obfuscate the usefulness of traditional voice mail and TAD devices. Even so, the present invention also applies to TAD-like machines, computers and networks by providing GID-based custom greetings upon recognition of the CID and linkage of that CID to the appropriate GID.

Grouper's primary strength resides in its ability to shield non-relevant and inappropriate information from callers while perceiving and delivering the information they are most likely seeking. Thus calls can proceed at an unprecedented rate and spawn greater productivity.

When an incoming CID is identified as belonging to a particular community (group), the group's rules apply immediately, thereby saving considerable time to both caller and owner. Since CID information is available after the first telephone “ring,” the call may be appropriately responded to and often terminated before a third ring would normally materialize.

Grouper provides an important gateway to group access of audio, SMS and MMS messages, GPS, telemetry, images, phone lists, spreadsheets, databases, documents and much more. Moreover, it blocks non-group members from group-imparted privileges.

### Common Gateway for Email, SMS, MMS and Audio Messages

The processing speed, power requirements and storage capacity of Sphone-like technologies provide considerable opportunities to manage communications through local, rather than centralized, networks. Such local control frees consumers and small business from the inflexibility and baggage associated with large networks.

A November 2006 survey by In-Stat indicates that more than 15 percent of Americans carry two mobile wireless devices. This is likely the harbinger of a trend that could culminate in Americans averaging two (or more) wireless devices. They'll simultaneously gate and manage multiple simultaneous instances of incoming calls and emails. They'll file, auto-respond/deliver and provide remote access to specified areas. Such configurations would provide a potentially constant flow of useful information—rather than the archaic telephone-tag style messaging pervasive today.

By indexing incoming email from the sender's header information, Grouper translates the email address into a CID and references it to a GID for standardization and to simplify instances in which CIDs reside in more than one GID. An email or voice message from the same individual would thus be viewed as part of the same Group. Incoming email is tagged with a delivery date, the “Last Contact” information in the contact file is updated and the email appropriately filed.

Consider a special instance of Grouper-based email and subscriptions management—news. One might receive news from several sources. Grouper allows these to be handled differently or the same. It is possible to delegate all technology news to one group and all world/local news to another. And the owner may stipulate (through the group profile and scripting) that technology news be purged after one week while world news is purged after two hours. Podcasts of radio shows, weather forecasts, horoscopes, river flow level information, statistics, sports scores, jokes of the day, music subscription feeds and mobile movie feeds can all be automatically grouped and easily maintained by priority.

### Automatic Group Filtering by Date

As explained above, if the group profile calls for automatic purging when content persists beyond a certain time limit, these will automatically be expunged—thus transitioning the oldest messages with the newest. And their automated removal noted as an addendum to log statistics.

### Call Screening

It is estimated that nearly 78 percent of adults with call-screening devices, use them. And nearly half of them say they screen their calls “always” or “most of the time.” In Grouper, if the GID-profile indicates the group is screened, the owner never hears the phone ring unless it is passed through by a caller. Grouper compares incoming CID information, matches it to a GID and delivers the appropriate message/information/menu. Grouped CIDs may receive SMS or audio greeting without owner intervention. Such a greeting may additionally provide menus to retrieve GID-specific information. Some groups may not provide any direct (ring-through) access. Others may require selection of the appropriate menu item (or key selection) to ring-through.

### Advertisement Management During ISO 14443 Account Transmission

Many cell phone and Sphone manufacturers have developed (or are in the process of developing) mobile phone/credit card hybrids. AT&T Wireless and Nokia are just two examples of many. The Nokia/MasterCard PayPass contains a Radio Frequency Identification (RFID) chip programmed with the owner's account information. When waved over a PayPass reader (a 13.56 MHz magnetic loop antenna) account information is transmitted to the terminal and processed similar to magnetic-card transactions. The RFID chip can be turned off remotely if the phone is stolen. Eventually similar units will permeate the marketplace and transit systems—debiting accounts and returning ads and coupons in the form of SMS and MMS files. Yes, they give as well as receive, and not just at the checkout counter.

Since proximity devices both send and receive information, these devices will likely appear in grocery store aisles, providing special coupon offers that can be accessed by RFID and automatically claimed at the checkout counter. They'll probably also confirm your membership at store chains.

Grouper provides for the separation of such RFID-transferred ads through placement in a separate GID section. There they would reside until time-purged, deleted, or viewed by the owner.

### Robo-Call Blocking Through Forced Menu Selection

Telemarketing spam has evolved to include SMS and MMS, with the receiver often incurring the costs. Some services (such as Verizon VZN) do not require a login or valid “from” telephone number, so it is easy to spam mobile phones. Grouper can use GID and prefix call-management to block such messages from unknown sources by refusing non-audio (SMS and MMS) input in the default “ungrouped” directory. Audio calls in the same “ungrouped” directory can be required to manually opt into a messaging or paging scenario after delivering a standard “if you are a solicitor, place this number on your Do Not Call list. Otherwise, to leave a message, press 1.” The Sphone never rings, the spam is never received. Or, in an alternative prefix-defined call, the spam is contained within a separate group for future viewing.

Known robo-message calls (such as the library notice systems and school attendance line) can be grouped so they automatically bypass the anti-spam gateway.

### Prefix-Parsing and Grouping of Marketing/Lobbying Calls

If an incoming CID is not associated in its entirety with any existing GIDs, it can secondarily be compared to prefix-based groups. The ability of Grouper to parse the prefix from the CID, and compare it with prefix-oriented groups can potentially block calls from unauthorized area codes such as toll-free trunks, other countries or, if someday available, prefix-delineated marketing, polling or campaigning agencies.

In a preferred embodiment of Grouper, telemarketing firms would have unique prefixes distinguishing them as telemarketers. Telephone survey and poll companies would have distinct prefixes distinguishing them as pollsters and Political lobbying groups would have distinct prefixes distinguishing them by category. Such a scenario, however would require enactment of federal legislation (described later).

### Surveys and Sales Calls

As described, Grouper can block telemarketers, shield potential survey respondents from unwanted participation and eliminate robo-messages, which are the mainstay of political campaigns. To bypass a properly configured default GID in Grouper, one must lie as well as select a menu option—just to leave a message. It's a hunch but I suspect the overwhelming majority of Americans would be unreceptive to callers practicing such deceit.

In fact, Americans, as a whole, are increasingly ambivalent and hostile towards random digit dial (RDD) telephone surveys, even when delivered in good faith. Telesurveyors are often regarded as pirates of privacy—purveyors of personal practices to unknown parties. Supporting this belief is the finding that over 58 percent of respondents from answering machine households who were promised money to participate in a survey and had completed the interview were still reluctant to furnish their name and address in order to receive their already-earned inducement. That's distrust!

On top of the problem of distrust, there are the problems of timing and frequency. The Do Not Call (DNC) lists enacted by state and then the federal government reflected the public's dissatisfaction with being interrupted with increasing frequency at increasingly inopportune moments. Even when the prospect is interested, the timing is often wrong.

SMS and MMS are currently hot marketing vehicles, especially when targeting a youth demographic. However, their overuse may soon spur tightening regulation. Even if it does not, Grouper provides a suitable wall against these bastions of direct marketing.

While Grouper makes practicable the complete avoidance of telemarketers, pollsters and politicians, it also provides a new tool through which they can provide productive public services, personable public contact and socially acceptable telephone-based prospecting for clients. And, it is done entirely with CID-gated grouping.

A large present problem is the difficulty in distinguishing telemarketing/polling/campaigning callers from personal or business-to-consumer service calls. If these callers were easily distinguishable through mandatory use of unique prefixes, Sphones could easily group and store messages in distinct categories (such as surveys, campaign messages and product incentives) to be retrieved at the owner's discretion on the owner's timetable. Such content might be retained and viewed during downtimes—such as commuting, waiting in lines, waiting on hold for customer support, etc. Users are more likely to interact with available content during such times, simply because it is a diversion and something to do. Such an arrangement would likely make prospects more receptive to messages, thus providing companies with an effective, inexpensive method of reaching a highly desirable demographic when they are most receptive—during their downtime.

If legislation were enacted requiring separate prefix designation for telemarketers, pollsters and campaigners, the ability to identify and block such entities would likely enable dismantling of current DNC laws because all access to content would be voluntary. This avails phone solicitors their First Amendment rights of freedom to disperse information while also venerating the public's unspoken right to freedom of peace and quiet during the few times it is available.

### Temporary Over-Ride of Default Group for Contact Management and Group Deployment

There are special instances in which a group may be used to collect contacts rather than sort them. To perform such a function, the group must temporarily become the default group and be configured to temporarily override all other screening to improve throughput. In other words, everyone calling the Sphone number is automatically assigned the GID of the group and becomes a subscriber. The scenario is best described through examples:

Alex is in front of an audience that is aware of his Sphone number. In preparation for this event Alex scripted Grouper to collect incoming SMS messages, assigning them the same GID and autoresponding an SMS of “Thanks for your dedication.” His Sphone does not ring.

Alex delivers a rousing speech. The crowd is feverish with enthusiasm—he has moved them to action. This is the moment when he can best leverage the crowd's interest. “Those who want to be part of this movement, SMS text me your email and smail addresses—tonight—NOW.” While he continues his speech, his pocketed Sphone collects the data, securing many contacts in a brief period. This “action group” may be used at a later date or to rapidly mobilize like-minded individuals through notification of a future event. If individuals in the action group call his phone in the future, they can be dealt with in a personal manner, keeping them informed without saturating Alex's available time.

The individuals in this auditorium could, just as easily, be voting at a stock holder meeting, contributing ideas at a city council meeting, or nominating individuals to office. Although the SMS text will vary, the process is similar in all of these cases. The technique could also be used to poll student understanding of a subject matter. “What is your answer to this problem?” may be the prompt that determines the further direction of discussion. It is anonymous to the class although the professor would know which students are in need of additional support.

### Polling

An overriding group is not necessary to conduct SMS polling of group members. In the simple case of a Scout troop, there could always be a menu option that asks persons to vote on possible activities at the next meeting—a simple consensus-building tool within a group already configured with CID participants.

### Call-Triggered Response Multiplexing

If desired, a group profile can allow multiple responses to a single call—without caller or owner intervention. Take for instance the case of a collaborative field project in which several individuals are monitoring each other's observations. An entry to the group “owner” can be bulk delivered to each member of the group. It may even be associated with a time-stamp of receipt. This would be useful in a brainstorming, field research, micro-blogging a subscriber list, etc. In a research and design context, it might be a running journal of a project and note interesting problems or features that have evolved. Unlike the traditional blog, these micro-blogs would be strictly controlled within a well-defined group. Such groups may range the gamut from bird-sightings to confidential engineering projects, and SMS would be added to the group and not necessarily be linked to any particular article. The same method can be used to distribute photos, movies or audio files.

Consistent with DNC regulations, callers may call your GID and select an option that removes them from automated updating functions, thus remotely updating the contact database.

In a more elaborate implementation, response multiplexing may involve the sending of a file to initiate the receipt of several others, scheduling an appointment and other scripted tasks that are built into that menu selection.

### Owner-Triggered Response Multiplexing

An incoming call need not trigger message multiplexing. In the instance of an elderly person who may require attention, the owner can “dial the group” with a command. Grouper would sequentially dial group members, delivering a message and menu options such as, “This is Joan Withersby at 1440 NW Witherspoon Drive. I'm in need of immediate attention. If you can help me, press 1 and this multiple request messaging device will not dial for help from any other individuals. If you cannot help me, press 2.”

### Immediate Call Processing

GID functions are initiated immediately upon CID match, thus eliminating the wait period during a fixed number of rings prevalent in legacy TADs.

### Group Monitoring and Call Logging

Group-scripting can provide owners the ability to monitor and analyze access to the group by automatically storing access data. Analysis of such data may provide the impetus to modify scripted menu options based on call duration, features visited, files retrieved, files updated, etc. Such analysis may also provide the basis for modification of rights conferred within a group or to an individual as those rights may be shown to be overutilized or underutilized. A simple monitoring output might be stored upon successful completion of a menu item. It may contain a threshold time period before tabulation. The output file may contain information such as Group, CID, Contact Name, Date, Time, Feature, Duration, Successful Completion, etc.

### Integration of Phone-Messaging Services with GID-Specific Calendar Information

Grouper integrates standard scripted variables in greetings. Such greetings may be output as SMS or audio (using a text-reader to read the message). A possible example of such scripting follows:

Example (Scouts, Single GID)

Hello <CID_FIRSTNAME>, our next event is <TITLE> on <ACTIVITY_DATE> at <ACTIVITY_TIME>. It will be held at <LOCATION>. <INSTRUCTIONS>. To talk to Dave, press 0. Otherwise select from these additional options.

1. Download all group members

2. Download all events know to date

3. Access another group

4. Participate in Scout survey

5. Modify your user profile

The message read to an incoming caller may be read as: “Hello John Hurley, our next event is the Fall BBQ on Oct. 14, 2006, at 3 p.m. It will be held in Avery Park near the Lion's Kitchen. To get to Avery park, take Third Street South, past the Mary's River bridge, past Papa's Pizza; turn right on Avery and follow Avery to the park. Scouts with a last name A-N are asked to bring a salad. All others bring something for the grill. Thanks and see you there.” And of course the menu items would be read off as “press 1 to . . . .”

In contrast to existing phone menu systems, this menu is specifically targeted to the needs of the caller, John Hurley.

In the instance of menu item 4, the CID and survey response will be added to the survey. And option 4 may be removed for this CID if caller has already accessed the menu item (as derived from the log file). Each menu option is separately scripted. Another simple SMS message while at the university library during finals week may read:

“I'm on the fourth floor of the Valley Library until 10 p.m. To leave a message, press 1.”

This would permit friends to locate you without you having to check your cell phone every few minutes.

### Greetings that Integrate Data from Native Contact Database

Since all CID information is contained in the contact database, a tremendous amount of personalization of messages is made available by using contact variables in scripting.

### Integration of Phone-Messaging Services with GID-Specific Data from Native Spreadsheet

Again, this can be customized messaging to present customers with appropriate spreadsheet information (such as their checking account balance) through scripted variables.

### Math and Boolean Logic with Variables from Spreadsheets, Databases and Clocks

Scripting math calculations and Boolean logic using available variables provides considerable messaging latitude. The scripted Boolean logic can furthermore become its own variable (see Scripts of scripts below).

### Scripts of Scripts

Once a script is created, it can be easily templated to other groups by making it a new variable. A long, involved script can be labeled General Script and placed in a definitions file. From then on, the <General Script> variable represents the content of the script in its entirety. This allows owners to quickly update many scripts just by changing one section of a component that would then be accessed by all scripts containing the variable.

### Syncing with PC Versions of the Same Software

Sphones from Palm use USB and Bluetooth® technologies to sync Sphone software files with PC files. Likewise, Grouper allows users to sync scripts, profiles, CID-to-group lists, Group menu lists and all other relevant database files through the native connection interface.

### Group and Individual Expiration rules—Time and Date Relevance

Grouper provides for an individual expiration date/time of members within each group. A member's time in a single group may expire although the member he/she may still be active in several other groups. Once a member's time expires in a group, the privileges of that group are no longer available to the caller. If expiring group is the “preferred” group, a new “preferred” group must be selected (see Preferred GID below).

### Preferred GID

Individuals contained in multiple groups are assigned a preferred GID with rights extending through all groups containing the individual. When an individual belongs to only one group, it becomes the default preferred group.

### Temporary Group Messaging Override Through Message Activation and Deactivation

Multiple messages can be available for a single group. Active messages are stacked chronologically and output to callers as a single message. Dormant messages are ignored until activated. The active/inactive toggle permits an owner to quickly defer active messages and advance a dormant message, completely revising the message landscape within a group in a matter of seconds.

### Time-Gated Group Addendum Messages

Sometimes the messages for a group are time-specific. If the message relates to the arrival time of a choir bus bringing kids home from a tour, it is a very short-lived message which, after the bus returns, should automatically be toggled to a dormant message. Since all messages can be time-gated, Grouper provides for considerable flexibility in complex messaging systems.

### CID-Gated Message Addendum

Grouper provides for individualized messages within a group message framework. At the beginning of the menu items would be an additional menu “Individual notes.” Upon selecting the menu item the caller would receive the additional messages particularized to that CID.

### Industry-Aware Templates and Programs

Grouper provides for custom industry-specific applications and scripts. An example of such software/scripts might provide a contractor with the ability to maintain inventory, ordering, payroll, bidding, billing, scheduling and inspection on Sphones. In this instance, customers could automatically view their bids or schedules involving their project, employees could order materials or manage their hours, inspectors could notify contractors of their intended inspection schedule and on-site inventory could be maintained. GID-profiles would assign the appropriate privileges to each of these categories.

### Automatic Updating of Contact Data with Sequence-Regulating Information

Grouper's ability to automatically update contact information and thus regulate subsequent uploads/downloads is particularly helpful in instances when callers need time-regarded information. In the case of the coordinator of a large choir, if singer has not called after a particular date, the coordinator knows the singer needs certain forms as well as a SMS description of the upcoming retreat. Otherwise the singer may need only an SMS file with information. By documenting the “last call in date/time” and the “last returned call date/time,” the information is easily accessed. The feature is also useful when returning messaged calls as described in “Sphone-queued continuous message playback and call-return within a group” below.

### Integration of Services with Remote-Access to GID-Specific Data Generated by Sphone Peripherals

Sphone-integrated peripherals should logically be brought into the domain of modern messaging, particularly scientific equipment, camera, GPS, etc. A simple temporary substitute for a webcam in a remote area could consist of an Sphone with its camera lens pointed in the proper direction. The Sphone listens for the incoming call, groups it and, if the rights exist, allows a caller to view the object toward which the Sphone camera is pointed. Such an application would significantly work in areas where wireless broadband services may not be available. Scientific research is rife with examples where remote data collection could be desirable through a cellular link. Through GID-gating, all people within the group would have access to the equipment while non-grouped individuals would be blocked.

### GID Dispatch Gating

In a dispatch-intensive business, GID responsive gating can be used to loop input variables in reply to incoming SMS messages. An incoming CID might be grouped to a region or a specialized function. When the CID is received and grouped, a Grouper-compatible database dispatcher would parse the incoming message from imbedded scripting. For a small tank-pump company, the message might read “<time> 2.75<job> tank pump <special notes> paid with check 23401.” The customer information for this job would already be known since it was the last job assigned to the CID. Upon receipt of the SMS, the dispatching software would mark the incoming job as complete, update the record, access the next unassigned job in the queue and send it to the caller. This new job would be marked “in progress” to prevent re-assignment before completion. In this manner, new jobs could also be posted to the cue.

### Secondary Password Protection for Sensitive Menu Options

In instances where information is sensitive, proprietary or otherwise regarded as worth shielding, Grouper provides for password-gated menu options. This can work in tandem with, or replace a machine ID key. Or it can be used to obtain the machine ID key—e.g., if the customer has the password and matching CID, the Sphone can assume the incoming machine ID is authentic, thus authenticating all subsequent sessions automatically. Since the protecting of menus with passwords slows the caller/owner information transfer interface, it would likely be used sparingly.

### Situational Ringtones and Emergency Pass-Through Options

Grouper allows ringtones to be assigned to a menu item, thus providing audible notations to situations rather than callers. This is useful when a jump beyond normal gateways can be achieved with a simple menu selection or key sequence. For instance, if the owner has provided an emergency pass-through option from the default non-grouped area, the call would ring through with an “emergency” ring tone.

The emergency ring-through option can also be conferred individually to members in the CID list. When such an option is on the CID member tag, the emergency ring-through option is added to the menu options of that member.

### Emergency Override

Grouper provides for the manual override of its entire gateway management system in cases of emergency. This feature effectively shuts down the program so natural cell-phone features can take over.

### Remote Access to Group-Specific Files

Grouper can be used to grant file access within a group. Such files might include documents, PowerPoint presentations, PDF-based forms, pictures, MP3, video and others. For instance, standard forms may be maintained on one group member's Sphone and be accessed by other callers in the group. These are most easily accessed through menu items.

### Automatic SMS Output to Caller without Input

Recognized group CIDs would be updated with particulars of an upcoming event in SMS only output. Such SMS messages would often be unified, group-specific messages containing updated information.

### Group Profile Options

An incomplete list of group profile options might include:

### Screen—Automatically greets the caller and/or delivers information directly stored on a recipient's phone without ringing.

### Retrieve Only—Allows only incoming SMS messages with no further group options.

### SMS Only—All greetings and file retrieval options are available only through SMS.

### Screen/Pass-through/Message—The caller must physically press an option key to page the owner whereupon the owner may choose to answer or allow voicemail response.

Pass-through/Message—The caller receives no message but is immediately routed to the owner. If the owner is unavailable, the call routes to voicemail.

### Screen/Option gateway—The caller is immediately presented with a menu of options.

### Group-based Contact Retrieval—The caller may view/download the group contact information.

### Re-broadcast of Message to Entire Group—The caller's input will be re-broadcast to all group members.

### Automatic SMS Input and Redistribution

For a group that shares things of interest to the entire group (e.g., research or news teams, groups, clubs, friends with common interests, family, sorority sisters, fraternity brothers, etc.), Grouper allows input to the gatekeeper group and redistribution throughout the group.

### Sphone-Queued Continuous Message Playback and Call-Return within a Group

One objective of persons who commute long hours is to be productive yet safe. Grouper allows owners to select a group and continuously playback messages within the group. This is particularly valuable for drivers. Pressing a key would automatically return the call and allow the owner to talk with the caller. Since the Sphone is used to make the call and the Sphone is used to collect messages, it is relatively easy to manage automated playback functions that track when messages are played and when they are returned. Such information can be used to queue the next message or determine if a further response is necessary.

### Auto-Responding to Email

Email auto-responders have been in use for many years, allowing stock replies to incoming email. Grouper auto-responds to email in the same fashion as it does to incoming SMS and audio messages—through GID-profiles and using GID-specific responses.

### EXAMPLES

Grouper groups callers by CID (or similarly-automated source-identifying codes) and targets each group with options appropriate to their specific needs.

The capabilities of Grouper can best be demonstrated through a fictitious example:

### John Smith

Consider the owner John Smith who, on a typical day might receive calls from:

Robo-dialing solicitors and pollsters

His mom

His doctor, dentist, chiropractor, psychiatrist or other family medical practitioner

A member of the 4-H pygmy goat group

Co-workers at the aquarium

Potential customers for his off-hours software design firm

His book agent

A member of his wind ensemble

A member of the son's cub Scout troop

His church group

His wife

His lawyer

His accountant

His golf buddies

The Grouper streamlines John's communication needs.

In the first instance, a non-grouped CID comes in but John does not even hear the phone because the “ring option” is toggled off for this group. The caller may hear a message such as, “If you are not a solicitor and wish to get a quote for custom programming or talk to John, press 1. If the caller pressed 1, it might page John or prompt the caller to leave a message with an explanation such as “John is in the field and will return your call when available” whereupon the caller's message will be recorded. In this fictitious instance, however, the robo-caller was thwarted.

John's elderly mother has recently fallen and he worries for her health. So he has no screening on calls with his mother's CID. Her unscreened calls will ring through to him—unless he is attending a concert or lecture in which his mobile phone is turned off. In this later instance, his mother would receive a message indicating his concern for her safety and allow her to press 1—to ring through in an IMPORTANT emergency—or to press 2—to leave a message.

The dentist's CID may likely reside in a family medical practitioner grouping and could be screened with a message such as, “If this is a reminder of an upcoming appointment, press 1. To page Mr. Smith, press 2.”

John's pygmy goat group is a SMS only group that notifies members of potential outings. In this case, the group is configured to automatically forward (push) SMS message to all group members excepting the originator of the message. This happens without intervention from John.

John is an underemployed programmer working as a sanitarian at the aquarium. He is on-call in case of emergencies and he prefers that his co-workers know as little as possible about his moonlighting efforts as a programmer. When he's on duty at the aquarium, callers seeking information about John's programming services would ring through or be routed to a message assuring them that John is only temporarily indisposed and will return their call shortly.

A customer will likely be screened during the hours John works at the aquarium and passed through when he is not likely at the aquarium (time/day sensitive screening). The screening message may allude to how much time he is “out in the field” this month and state that if they press 1 to leave a message, John will get back to them ASAP. On his long commute, John can auto-redial the entire Custom Programming group in accession order enabling him to respond with minimal distraction during the foggy evening drive home.

The book agent needn't know about John's lives as sanitarian or nerdy programmer. He is under the delusion John is an inspired novelist. The message will be tailored to enhance this perception but the agent will be screened from John while John he is working at the aquarium. The agent can leave a message.

Since John leads the wind ensemble, an audio message will indicate specifics of an upcoming concert to be held at the Farmer's Market. Callers will press 1 to leave a message, 2 to look up another member's phone number, or 3 to leave a message such as “I can't be there.”

John is in charge of the Yosemite hike with his son's Cub Scout troop. CID's recognized for this group would get updated information on where the previously poorly-mapped camp site is situated as well as be able to access GPS info on John that weekend. In this fashion, straggling Scouts could attempt to meet up with the group. The message may be, “The meeting is in the Yosemite Park upper campground at 2:30 p.m. If you are calling after 2:30 and having trouble finding the group, the GPS coordinates are <GPS coord>. To see the text message instructions for locating this meeting, press <T>.” Variables for outputting common functions such as SMS message, GPS coordinates and call forwarding would be a pre-programmed into the commercial product. Furthermore, Scouts sending John pictures would automatically have the pictures forwarded to all other Group members. Sharing on-the-fly photos may enhance the experience.

Similarly, John's church group, wife and golf buddies could be handled in a fashion consistent with their needs and John's desire to portray himself in a manner commensurate with the group's profile.

### Hacking or Faking CID Information

Grouper's primary focus is protecting people from information. Unfortunately, it is also true that some information must be protected from people.

In a preferred embodiment of Grouper, an Sphone would positively ID a caller using a unique ID code that cannot be spoofed. Such a code is accommodated by Grouper and would preclude the need for further security. In the meantime, the omnipresent CID provides adequate identification and, with augmentation, can provide sufficient security. One possibly secondary security code resides in the use of an Sphone machine ID code passed between Sphones. In such a scenario, Grouper would still use the CID to appropriately group the caller but the machine ID would provide session authentication and a secure key to sensitive information. Another reasonably secure system is the use of passwords to protect specific menu gateways. Users requiring a further level of protection can employ file encryption to render useless all files retrieved in an unauthorized manner.

To properly access the security threat as well as the benefit of such secondary protection, it is instructive to examine the manner in which a violation would occur as well as its possible outcome.

The CID data-stream is transmitted between the first and second rings—before the phone call is connected. Spoofing this stream is simple and commonplace. Even Paris Hilton was accused spoofing caller ID to break into a voicemail system in August 2006.

Spoofing can be originated through services (including Verizon VZN) that do not require a login or valid “from” telephone number. VoIP, however, remains the favorite technology to fake a call's origin. Services such as Vonage or Skype can be used to forge a CID. And commercial spoofing industries (including Spooffel.com, Telespoof.com, Spoofcard.com and SpoofCom.net) have been removing the guesswork from caller deception since they were first pioneered by the now defunct Sar38.com in September 2004.

While spoofed entry confers to the caller the privileges of the group, such privileges are usually of questionable import to intruders. Spoofing the CID of a scout in the Cub Scout group may endow the intruder with knowledge pertaining the next meeting, a contact list or a PowerPoint presentation of the next science lab. If the contact list is further protected by a secondary password, the intruder would require the password to secure additional privilege.

Grouper relies on accurate caller identification to expedite the conveyance of information important to the caller while minimizing the time spent in such conveyances. If the caller has spoofed the CID, the information relayed will, most likely, be of little use.

Regular security breeches in Grouper are also made evident through stored activity logs/statistics and may be dealt with through modification of group privileges or increased section security using password-protected menu options or encrypted files. A group's privileges should accommodate members without compromising them.

Aside from phishers and pranksters, many legitimate services/individuals regularly counterfeit their outgoing CID code. Commercial answering services, for instance, forward their received calls to subscribers with the originator's CID displayed (not the network). And salesmen calling from remote locations often display their business CID rather than their home number while on the road. The prevalence of individuals owning multiple cell devices has decreased the need to spoof CID information. According to a Nov. 25, 2006, survey by In-Stat, more than 15 percent of people carry two wireless phones. While it is unclear whether or not CID will endure as currently defined, Grouper's use of password gateways to sensitive information and encryption of proprietary files provide satisfactory overall security without encumbering users. Since Grouper technology is not dependent on the ID that uniquely defines a caller, new formats can be readily adapted into Grouper by those knowledgeable in the field.

### Disabled CIDs

A larger problem for Grouper than spoofed CIDs is missing CIDs. If Grouper does not receive a CID, it is incapable of appropriately grouping the caller. This problem can be addressed by allowing blocked CIDs to enter their phone numbers from a menu option in the default group. This creates needless bottlenecks in the system and will most likely need to be overcome through education. As callers and users become educated in how Grouper-based, pre-emptive information servers can save them time, the problem will diminish. If callers are going to call a Grouper-enabled device, their CID should be enabled.

It is useful to quickly review the manner in which CID information is blocked from devices and software such as Grouper. In North America, there is one code to disable Caller ID. The code is *67. In the United Kingdom and Ireland, 141 is the equivalent code. Australia uses 1831. Hong Kong uses 133. Israel uses *43. On GSM mobile networks, callers may dial #31# before the number you wish to call to disable the readout of the CID stream.

Those skilled in the art will recognize that any/all Grouper functions described above (or equivalents) can be readily programmed with existing applications development software on existing Sphone platforms.

(a) Prior Art

Prior art consists of the standard TAD, network voice mail services and computer-based software (such as EzVoice) that allow recording of unique voice greetings for callers based on their CID and of network overlay services (such as YouMail) that provide the similar capabilities through an Internet subscription service.

Typically a phone call comes in and, after ringing a pre-selected number or times, the TAD or VM determines the owner is unavailable to take the call and plays an automated greeting that is inherently too generalized to suit the purposes of any calling group. A message might consist of: “Good day. You have reached (insert business/family name and telephone number). We are unable to take your call at the present time, but your message is important to us. Please leave your name, number and message after the beep. Thank you for calling.” The message is typically digitized and stored on the answering device or responding network. It's a simple record/playback system. Yet in the minute and a half the ‘Scout’ spent waiting for the message to pick up, listening to it and then leaving a message, Grouper could have told six Scouts that the meeting is at 6 p.m. at Dan's house at 3456 Crystal Garden Rd. and relayed a full set of directions as well as the respective responsibilities of each Scout, including who is providing the cookies. Furthermore, the message left on the traditional TAD probably will not be returned until it is too late—because Dan's taking care of last-minute preparations for the meeting, after working all day. And by the time he listens to the message, returns it and apologizes, Grouper could have handled six additional calls from Scouts.

Voice messages are routinely extended with menus, voicemail boxes, information about hours of availability, etc. Often, they are narrated by a smarmy kid, rambling for what seems like a century, before a message can be left. Or they provide a musical interlude followed by, “Please leave a message.” And, thanks to the favorite American pastime, telephone tag, a caller may often get the exact same message a dozen times in a day—never successfully getting the desired information—but always getting a novella read by a smarmy kid.

When operating a small business, first impressions are important, as is the rapport between a client and owner. If a client calls and starts playing telephone tag or has to listen to a smarmy kid, it is not nearly as impressive as calling, getting an Sphone program that identifies and greets the client by name, provides menus from which orders may be left and current price sheets retrieved or provides a calendar on which appointments can be scheduled or the date of the next local visit determined.

Business relations are but a subset of human relations. Grandma does not want a price quote or to know when the next choir meeting is, she wants to speak with the smarmy little kid but only if you are unavailable to take the call. And a dozen choir kids calling to ask when they have to show up to the dress rehearsal is not any more a satisfying accompaniment to one's dinner than a call from a pollster. Yet Grouper handles all these scenarios seamlessly—once the owner places similarly-managed CIDs into a GID cluster. Most such situations can be handled without even talking to someone on the phone and all are determined through GID-gating of Sphone features. Sphone scheduling software and contact information is regularly updated, owing to its ease and proximity. So the information being relayed is up-to-date and does not require extra effort. Grouper's GID simply allows contextual passing of this information to callers.

As shown above, a big problem with prior art is that the same message plays regardless of whether the caller is the owner's child, parent, business associate, librarian, customer, cub-Scout member, golf buddy or spouse. The same message plays whether it is Sam who cannot remember when your son's soccer game is or Ted, informing you that you'll have to spend an additional month in Tokyo working on the company software installation.

In some voice mail systems, such as systems commercially available from Octel Communications Corporation, VMX, Inc., and IBM Corporation, if the caller calls from a telephone from within a PBX with which the system is associated, the system can play an internal message. However, if a caller calls from a telephone that is not within the PBX, the system will be able to determine, and perhaps indicate, only that the caller is “an outside caller” and will play an external message.

It is likewise common for ringtones to select for a fax or external device. Still, these options are not adequate and are fundamentally different from Grouper technologies. By using the CID as a gateway to Group privileges, Grouper addresses individuals based on their communications needs, thus preventing the frivolous waste of caller time listening to misdirected communication, inappropriate options and often inappropriate audio messaging.

It is also common, in the prior art, to attach individualized ringtones to differentiate incoming calls based on the CID-stream. In fact, In-Stat estimates that ringtones sold worldwide amount to nearly $3.5 billion. The purpose of ringtones is to screen calls without viewing the CID display. Often, unique ringtones are applied to each CID. Grouper still allows such practices. Additionally, Grouper allows ringtones to be based on situational, rather than CID circumstances. However, Grouper provides much more than an auditory or visual call screening. It can screen without any auditory or visual displays—conferring rights to group/user-accessible files and information and, through a user's preferences, determining automatic output as SMS, MMS or audio.

EzVoice and YouMail allow customized greetings in much the same manner as a CID selects for a ring tone. Such a proposition is time-intensive and extremely limiting. The Grouper's time-saving provision of clustering callers of similar interest provides for individualized messaging and much more.

Blocking telemarketers is not a new phenomenon. Caller-ID devices, TeleZappers and privacy managers have been around for decades. Grouper is Communications Management Software. It is a more robust, versatile and specific call-blocking system than anything in the prior art.

Those skilled in the art will recognize that any/all Grouper functions described (or equivalents) can be readily programmed with existing development software on existing Sphone platforms.

What is claimed is:

1. A Communications Management software system and a method comprising the steps of:
a) receiving an incoming call through a mobile smart phone (or similar communications device that permits the installation of native applications)
b) comparing the incoming CID datastream (or similar identifying code) to a stored file (or relational database) to determine if the CID is linked to at least one active Group Identification Code (GID) and also determining that the caller's membership in said group(s) is not expired;
c) if the CID is linked to multiple GIDs, relating the CID to a contact (or similar) file to determine which is the preferred (GID);
d) if the CID is not yet assigned a GID, parsing the prefix from the CID and comparing it with prefix-based groups (if any);
1) if the prefix of the CID matches a prefix-based GID, assigning that GID to the CID;
2) if the CID remains unlinked to a GID, assigning the caller the GID of the “default” group which confers minimal rights to callers;
e) establishing through the GID-profile if the call is in a screened Group and whether SMS and/or MMS messaging is blocked within the group;
f) if the caller is in a screened group, establishing through the GID-messaging/menuing file (relational database) what greeting(s) (if any) and menu components (if any) apply;
g) If multiple active (unexpired) greetings or menu components apply, assembling such components (if any) by the priority attributed to each component within the file and incorporating into said components (if any) the information from all recognized scripted internal variables as well as those which may be linked to external contact lists, schedulers, clock functions, databases, spreadsheets, and peripheral devices;
1) If mathematical or Boolean functions operate on variables or are themselves contained within a script-defined variable, these shall be evaluated in toto, transmitting the solution rather than the components;
2) If a script-defined variable consists of another script, the contents of said variable will be treated as though the language contained were completely extracted prior to transmitting the script of which it is a part.
h) transmitting said greeting to the caller (using SMS, MMS or digitized audio) with additional plurality of option as established in the group profile and GID-scripted menu options;
i) exercising said options through menu selection, speech recognition, an entered key sequence; or SMS scripting.
j) if the emergency pass-through option (if allowed) is selected, notifying the owner through an event-specific ringtone that urgent attention is required.
k) protecting menu access (if designated) using passwords or transference of a previously verified and recorded machine ID code;
l) if established through the GID-profile and scripting, provide multiple responses to a single call without caller or owner intervention (response multiplexing);
m) if initiated by the owner, commence a response multiplex cycle which sequentially dials and polls group members for responses to a question until an appropriate response from a group member terminates the calling sequence;
n) if initiated by the owner, over-ride all message screening with a single “action” group scripted to receive incoming SMS calls and automatically assign all CIDs to said group GID;
o) automatically update contact database with LAST CALL RECEIVED, LAST CALL RETURNED and DURATION OF CALL information;
p) automatically log call information to an analysis file which monitors group access by scripted feature, recording information such as GID, CID, Date, Time, Feature Visited and Visit duration;
q) if initiated by the owner, queue continuous message playback of recorded messages from within a group. At any time during this playback, the message may be paused and the call automatically returned with a simple voice command, keystroke or menu selection.
r) separation of all content imported through ISO 14443 devices into a single group GID location;
s) syncing between Sphone and PC versions of the same scripts/menus/databases through use of native connections such as USB, Bluetooth® or RF.
t) a manual over-ride of the gateway management system can be accomplished by typing a system-defined key sequence which shuts off all screening functions and allows native cell-phone features to supersede.

2. The system according to claim 1 wherein additional plurality of option [1h] relates to GID Dispatch Gating in which;
a) an incoming SMS message contains record field variables followed by their respective values;
b) upon receipt of said message, the Communications Management software opens the record last sent to the CID (with a status of IN PROGRESS) and records the field values to the dispatch record as well as the completion time;
c) changing the record status from IN PROGRESS to COMPLETED and closing the record with the new field entries included;
d) locating the next unassigned GID-related record within the file with a status of OUTSTANDING and transmitting said record (or owner determined fields from said record) via SMS message to the CID;
e) recording (within the record) the caller CID as the RESPONDER as well as the system clock value as DISPATCH TIME/DATE;
f) marking the record status as IN PROGRESS;
g) closing the updated record and awaiting the next incoming dispatch-related call.
h) upon receiving a SMS message containing field data followed by a command <STOP>, recording the sent information without sending a new dispatch record.
i) upon receiving a SMS message containing no field data and the command <START>, initializing the dispatch cycle by sending the next OUTSTANDING record in the file (relational database).

3. The system according to claim 1 wherein additional plurality of option [1h] relates to
a) remote access to group-specific files including (but not limited to) documents, PowerPoint presentations, PDF-based forms, pictures, mp3, video, and others;
b) remote access to group-specific files within applications such as appointment schedulers, spreadsheets, databases, media players, word processors, inventory management software, purchasing software, time-management software, etc.

4. The system according to claim 1 wherein the Communications Management software provides a common gateway for email, SMS, MMS, and audio messages by;
a) relating parsed email header information to a contact file (or relational database) to determine the CID;
b) relating the CID from the contact file (or relational database) to the database linking CIDs and GIDs to determine if the CID is linked to at least one active Group Identification Code (GID) and also determining that the caller's membership in said group(s) is not expired;
c) providing an auto-response (if designated in the GID profile) to the email address rather than the CID;
d) automatically update contact database with LAST CALL RECEIVED, LAST CALL RETURNED and DURATION OF CALL information;
e) automatically log call information to an analysis file which monitors group access by scripted feature, recording information such as GID, CID, Date, Time, Feature Visited and Visit duration;

5. The system according to claim 1 wherein
a) the Communications Management software is a stand-alone product and all functionality and variables are internal including contact databases, calendar/appointment databases, spreadsheets, clock, GPS, dispatch databases, inventory databases and accounting databases.

6. The system according to claim 1 wherein
a) The Communications Management software is a front-end with external variables linked to existing applications resident on the smart phone. These might include MS Word, MS Access, MS Excel, MS PowerPoint or similar applications.
